(19) United States
(12) Patent Application Publication
(10) Pub. No.: US 2009/0147018 A1
(43) Pub. Date: Jun. 11, 2009

(54) IMAGE SENSING APPARATUS AND CONTROL METHOD THEREOF

(75) Inventor: Hirofumi Takei, Yokohama-shi (JP)

Correspondence Address: COWAN LIEBOWITZ & LATMAN P.C.;JOHN J TORRENTE, 1133 AVE OF THE AMERICAS, NEW YORK, NY, 10036, US

(73) Assignee: CANON KABUSHIKI KAISHA, Tokyo (JP)

(21) Appl. No.: 12/330,213

(22) Filed: Dec. 8, 2008

(30) Foreign Application Priority Data
Dec. 11, 2007 (JP) 2007-320064

(51) Int. Cl. G09G 5/02; H04N 5/228

(52) U.S. Cl. 345/590; 348/222.1; 348/E05.031

(57) ABSTRACT

An image sensing apparatus comprises a signal processor that performs processing corresponding to a plurality of color gamuts for image data, an image recording unit that records the processed image data, an image displaying unit that displays the processed image data, a first selector that selects a color gamut of image data to be recorded in the image recording unit from the plurality of color gamuts, and a second selector that selects a color gamut of image data to be displayed on the image displaying unit from the plurality of color gamuts, during recording of image data of the color gamut selected by the first selector in the image recording unit, image data of a plurality of color gamuts are displayed on the image displaying unit by switching selection by the second selector while maintaining a selection state by the first selector.

### BACKGROUND OF THE INVENTION

1. Field of the Invention

The present invention relates to an image sensing apparatus for displaying and recording shot images.

2. Description of the Related Art

As an RGB color gamut for a color image, a plurality of color gamuts are defined. However, image sensing apparatuses which comply with wider color gamuts have been put into practical use in recent years. For example, in image sensing apparatuses such as digital cameras for shooting still images, a color gamut called SRGB has been mainly used so far. Also, in displays for displaying shot still images, their displayable color gamuts have been mainly sRGB. However, in recent years, a number of digital cameras and displays that can perform image processing corresponding to a color gamut called AdobeRGB, which is wider than sRGB, are becoming commercially available.

On the other hand, in a television camera for shooting a moving image, a color gamut similar to SRGB, which is defined by ITU-R BT.709 (BT.709 hereinafter) for broadcasting, has been used so far. Recently, however, an extended color gamut for moving images wider than BT.709 has been proposed for moving images as well, and has become an international standard as IEC61966-2-4 from IEC (International Electrotechnical Commission).

A color gamut defined by this standard is referred to as the xvYCC (extended color space for moving images) color gamut, and image sensing apparatuses and display devices which comply with this standard have been developed.

An image sensing apparatus and display device using the xvYCC color gamut are proposed in Japanese Patent Laid-Open No. 2006-033575.

As described above, as for a display device for a television or a computer display, a display device that can display not only the conventional sRGB color gamut but also the AdobeRGB color gamut or xvYCC color gamut has been put into practical use.

Along with definition of a plurality of different color gamuts as described above, an image sensing apparatus represented by a digital camera that allows a user to select one of a plurality of color gamuts as needed, performs processing corresponding to the selected color gamut to image data, and records the processed image data has also been put into practical use. The conventional technique of such an image sensing apparatus is described in Japanese Patent Laid-Open Nos. 2004-096400 and 2005-292814.

The arrangement of a conventional image sensing apparatus that can select a plurality of color gamuts is shown in FIG. 14.

Referring to FIG. 14, an optical image from an object is imaged in a CCD 1402 via a lens 1401 and photo-electrically converted.

A signal that is photo-electrically converted in the CCD 1402 undergoes known gamma processing, color matrix processing, or the like in a camera signal processor 1403, and is output as camera image data.

Camera image data output from the camera signal processor 1403 is input to an image recording unit 1404 and image displaying unit (finder) 1405 for image confirmation.

In the image recording unit 1404, camera image data undergoes an image compression process such as JPEG, MPEG2, or the like, and the resultant data is recorded in a recording medium 1406 such as a magnetic tape or memory card.

An operation unit 1407 performs various kinds of operations of the overall image sensing apparatus such as start and stop of recording, designation of a color gamut to be recorded, and the like.

Reference numeral 1408 denotes a system controller that controls the overall image sensing apparatus. Reference numeral 1409 denotes a memory in which the control program of the system controller 1408, matrix coefficients corresponding to a plurality of color gamuts, and the like are stored.

An operation of changing the color gamut of an image to be recorded by a user is briefly described now.

A user operates the operation unit 1407 to designate a color gamut that he/she wants to record from a plurality of color gamuts. Then, the system controller 1408 reads in a color matrix coefficient corresponding to the selected color gamut from the memory 1409, and outputs it to the camera signal processor 1403.

The camera signal processor 1403 performs color matrix processing in accordance with the input color matrix coefficient, thereby generating image data corresponding to the designated color gamut.

As a result, camera image data that has been processed using the color gamut designated by the user is output to the image recording unit 1404 and image displaying unit 1405.

In some arrangements, upon reproducing an image, the chroma of the image displayed on the image displaying unit 1405 can be adjusted in accordance with the color gamut of the recorded image.

In the above-described Japanese Patent Laid-Open Nos. 2004-096400 and 2005-292814, for example, when a user wants to switch images that have been processed using a plurality of color gamuts and display them on the image displaying unit 1405 during image recording, the color gamut processed in the camera signal processor 1403 needs to be switched.

However, if the user changes the color gamut processed in the camera signal processor 1403 while successively recording images, the color gamut of image data recorded in the recording medium 1406 changes in the middle of successive images, resulting in a change in tint in the middle of a scene. For this reason, when the user wants to confirm an image processed using a color gamut different from that used for an image being recorded during image recording, he/she stops the recording operation once, confirm the image of the switched color gamut on the image displaying unit 1405, and starts image recording again. This is a complicated operation.

As described above, in a conventional manner, it is difficult to confirm on the image displaying unit 1405 an image processed using a color gamut different from that used for an image being recorded, without affecting the tint of the image being recorded during image recording.

### SUMMARY OF THE INVENTION

The present invention has been made in consideration of the above-described problem, and implements a technique that can switch and display an image processed using a color gamut different from that of an image being recorded at any time, without affecting the image being recorded.

To solve the above-described problem, according to the present invention, there is provided an image sensing apparatus comprising: an image sensing unit adapted to sense an image of an object; a signal processor adapted to perform processing corresponding to a plurality of color gamuts for image data obtained by the image sensing unit; an image recording unit adapted to record image data processed by the signal processor; an image displaying unit adapted to display image data processed by the signal processor; a first selector adapted to select a color gamut of image data to be recorded in the image recording unit from the plurality of color gamuts; and a second selector adapted to select a color gamut of image data to be displayed on the image displaying unit from the plurality of color gamuts, wherein during recording of image data of the color gamut selected by the first selector in the image recording unit, image data of a plurality of color gamuts are displayed on the image displaying unit by switching selection by the second selector while maintaining a selection state by the first selector.

There is also provided a control method of an image sensing apparatus including an image sensing unit adapted to sense an image of an object, a signal processor adapted to perform processing corresponding to a plurality of color gamuts for image data obtained by the image sensing unit, an image recording unit adapted to record image data processed by the signal processor, and an image displaying unit adapted to display image data processed by the signal processor, comprising: a first selection step of selecting a color gamut of image data to be recorded in the image recording unit from the plurality of color gamuts; and a second selection step of selecting a color gamut of image data to be displayed on the image displaying unit from the plurality of color gamuts, wherein during recording of image data of the color gamut selected in the first selection step in the image recording unit, image data of a plurality of color gamuts are displayed on the image displaying unit by switching selection in the second selection step while maintaining a selection state in the first selection step.

According to the present invention, it becomes possible to display on an image displaying unit the image of a color gamut different from that of an image being recorded even during image recording, without changing the color gamut of the image being recorded. Therefore, it is possible to switch and display images processed using a plurality of color gamuts on the image displaying unit without affecting the tint of the image being recorded.

Further features of the present invention will become apparent from the following description of exemplary embodiments with reference to the attached drawings.

### BRIEF DESCRIPTION OF THE DRAWINGS

FIG. 1 is a block diagram showing the arrangement of a video camera of an embodiment according to the present invention;

FIG. 2 is a block diagram showing the arrangement of a first color gamut signal processor;

FIG. 3 is a graph illustrating the BT.709 color gamut and the color gamut of an image sensor;

FIG. 4 is a graph showing the gamma characteristic of xvYCC;

FIG. 5 is a graph illustrating a relationship for converting a luminance signal into a digital value;

FIG. 6 is a graph illustrating a relationship for converting a color difference signal into a digital value;

FIG. 7 is a graph illustrating ranges of a BT.709 signal and an xvYCC signal;

FIG. 8 is a block diagram showing the arrangement of a second color gamut signal processor;

FIG. 9 is a graph illustrating color gamut compression into BT.709;

FIGS. 10A and 10B are views illustrating storage examples of gain correction tables in a memory;

FIGS. 11A and 11B are views illustrating menu windows upon selecting color gamuts;

FIG. 12 is a view illustrating a display example of color gamut information;

FIG. 13 is a block diagram showing another arrangement of the second color gamut signal processor; and

FIG. 14 is a block diagram showing the arrangement of a conventional image sensing apparatus.

### DESCRIPTION OF THE EMBODIMENTS

An embodiment according to the present invention will be described in detail below with reference to the accompanying drawings.

Note that the embodiment to be described below is an example to implement the present invention, and should be appropriately modified or changed in accordance with the arrangement of an apparatus to which the present invention is applied or various conditions. The present invention is not limited to the embodiment below.

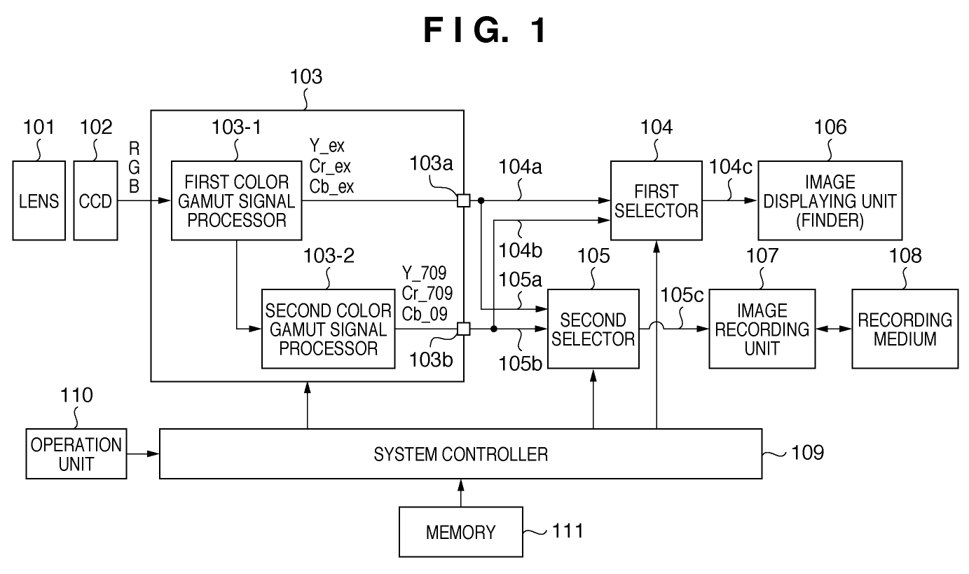

FIG. 1 is a block diagram showing the arrangement of a video camera to which the present invention is applicable.

Note that in the description below, for the sake of simplicity, a camera signal processor that performs processing corresponding to a plurality of color gamuts will be described to process two kinds of color gamuts, that is, xvYCC and BT.709 described above.

In FIG. 1, reference numeral 101 denotes a lens; 102, an image sensor such as a CCD; and 103, a camera signal processor that performs processing corresponding to two kinds of color gamuts.

A first selector 104 selects one of image signals processed in accordance with the two kinds of color gamuts, and sends the selected signal to an image displaying unit 106.

A second selector 105 selects one of image signals processed in accordance with the two kinds of color gamuts, and sends the selected signal to an image recording unit 107.

The image displaying unit 106 displays an image. The image recording unit 107 performs processing such as image compression associated with recording of image data. Reference numeral 108 denotes a recording medium including a magnetic tape, nonvolatile memory, or the like in which image data is recorded.

Reference numeral 109 is a system controller that controls the overall video camera.

Reference numeral 110 denotes an operation unit that receives an operation from a user; and 111, a memory that stores the program of the system controller 109, a gain correction table to be described later, and the like.

The operations of the respective blocks shown in FIG. 1 will be described next.

First, an optical image from an object undergoes zooming, focusing, and adjustment of a stop by the lens 101 and is imaged on the image sensor 102. R, G, and B signals corresponding to the optical image of the object are generated in the image sensor 102.

Note that the image sensor 102 in this embodiment is assumed to have characteristics corresponding to a color gamut wider than that formed by R, G, and B primary color points defined by BT.709.

The primary color points of BT.709 and those of the image sensor of this embodiment will be described with reference to FIG. 3.

FIG. 3 is a general xy chromaticity diagram. In FIG. 3, the region inside a triangle 301 represents a color gamut range of the R, G, and B primary color points defined by BT. 709.

The region inside a triangle 302 represents a color gamut range of the R, G, and B primary color points of the image sensor 102. The region inside an area 303 represents the entire range of visible light that a human can recognize.

In this embodiment, R, G, and B signals output from the image sensor that complies with a color gamut wider than BT.709 as represented by the triangle 302 are input to the camera signal processor 103.

The camera signal processor 103 includes a first color gamut signal processor 103-1 and a second color gamut signal processor 103-2. A signal output from the first color gamut signal processor 103-1 is input to the second color gamut signal processor 103-2.

A signal output from the above-described image sensor 102 is first input to the first color gamut signal processor 103-1 in the camera signal processor 103.

The arrangement and operation of the first color gamut signal processor 103-1 are described now.

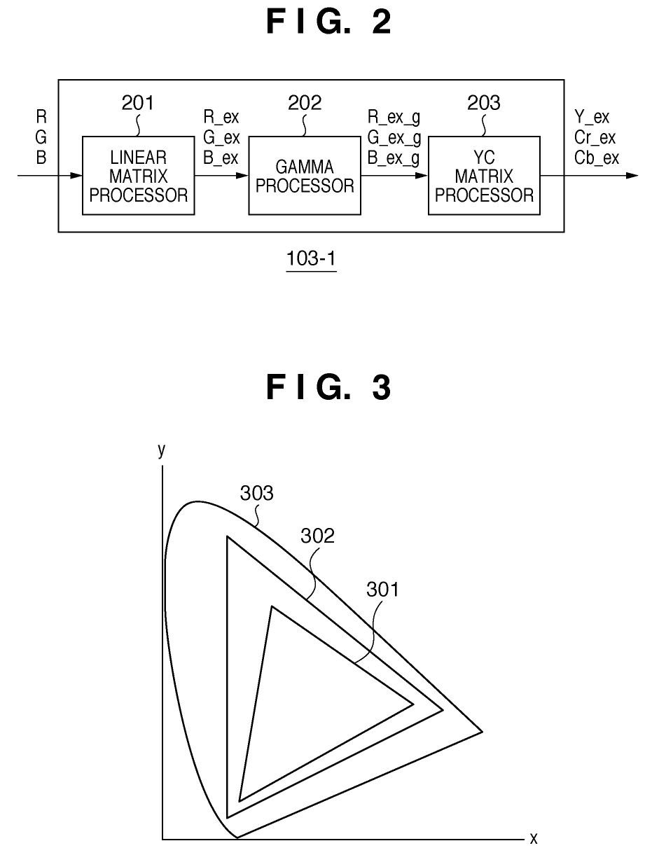

FIG. 2 is a block diagram showing the arrangement of the first color gamut signal processor.

The processing method of the first color gamut signal processor in this embodiment is a processing method for a signal having a color gamut wider than that of the R, G, and B primary color points defined by BT.709, and its details are described in the above-described IEC61966-2-4 and Japanese Patent Laid-Open No. 2006-033575. Therefore, only an outline of the processing will be described herein.

Referring to FIG. 2, a linear matrix processor 201 performs 3×3 linear matrix processing for R, G, and B signals output from the image sensor 102 and converts them into R_ex, G_ex, and B_ex signals, respectively, based on BT.709.

In this linear matrix processing, when each of the input R, G, and B primary color points of the image sensor 102 is in the neighborhood of the corresponding primary color point defined by BT.709, each of the R_ex, G_ex, and B_ex signals to be output varies between 0 and 1.

However, when the primary color points of the image sensor have a range wider than that formed by the primary color points defined by BT.709 as represented by the triangle 302 in FIG. 3, each of the R_ex, G_ex, and B_ex signals to be output may take a negative value or a value larger than 1.

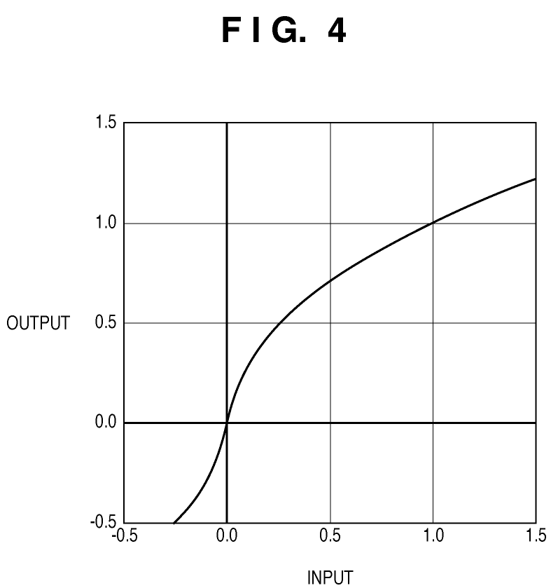

The R_ex, G_ex, and B_ex signals that underwent the linear matrix processing in this manner are then input to a gamma processor 202. The input/output characteristic of the gamma processing performed in the gamma processor 202 is shown in FIG. 4.

As described above, each of the R_ex, G_ex, and B_ex signals to be input to the gamma processor 202 may take a negative value or a value larger than 1, in addition to a value between 0 and 1 (both inclusive).

Accordingly, when the input is a value between 0 and 1 (both inclusive), it has a gamma characteristic defined by BT.709, and when the input is a negative value or a value larger than 1, it has a characteristic obtained by extending the gamma characteristics.

R_ex_g, G_ex_g, and B_ex_g signals that underwent the gamma processing using the characteristic shown in FIG. 4 are input to a YC matrix processor 203.

In the YC matrix processor 203, the R_ex_g, G_ex_g, and B_ex_g signals are converted into a luminance signal Y_ex and color difference signals Cr_ex and Cb_ex by a 3×3 matrix equation defined by BT.709, such as:

$$( \begin{matrix}Y\_ex \\ Cb\_ex \\ Cr\_ex\end{matrix} ) = ( \begin{matrix}0.2126 & 0.7152 & 0.0722 \\ - 0.1146 & - 0.3854 & 0.5000 \\ 0.5000 & - 0.4542 & - 0.0458\end{matrix} ) ( \begin{matrix}R\_ex \_g \\ G\_ex \_g \\ B\_ex \_g\end{matrix} )$$

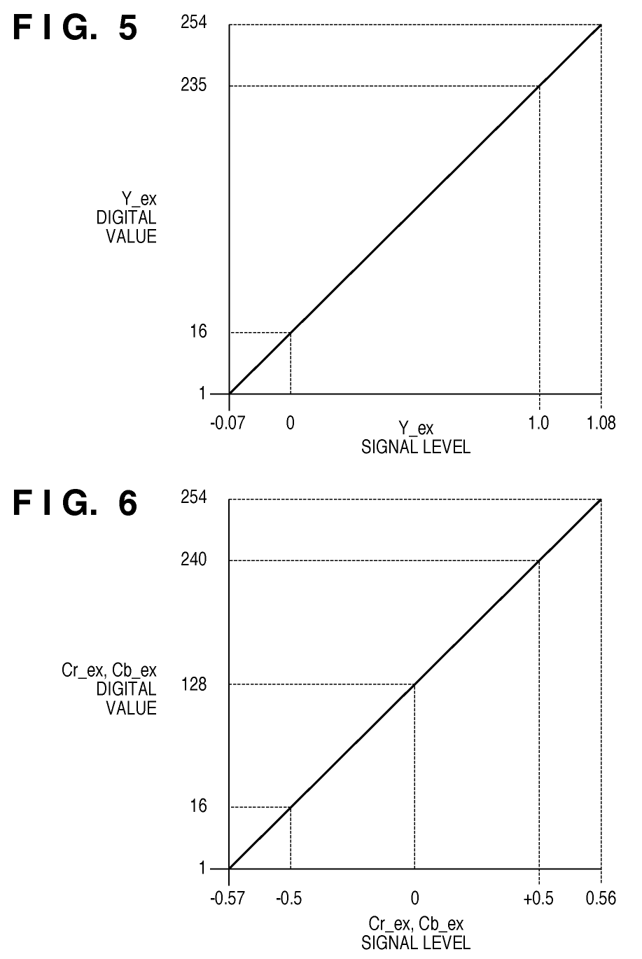

The luminance signal Y ex obtained by the above-described equation is assigned an 8-bit digital value (from 0 to 255) as illustrated in FIG. 5. For example, when the signal level of Y_ex obtained by the above-described equation is 0, it is assigned a digital value of 16. When the signal value of Y_ex is 1.0, it is assigned a digital value of 235.

Also, each of the color difference signals Cr_ex and Cb_ex is assigned an 8-bit value (from 0 to 255) as illustrated in FIG. 6. For example, when the signal level of Cr_ex or Cb_ex obtained by the above-described equation is −0.5, it is assigned a digital value of 16. When the signal level of Cr_ex or Cb_ex obtained by the above-described equation is +0.5, it is assigned a digital value of 240.

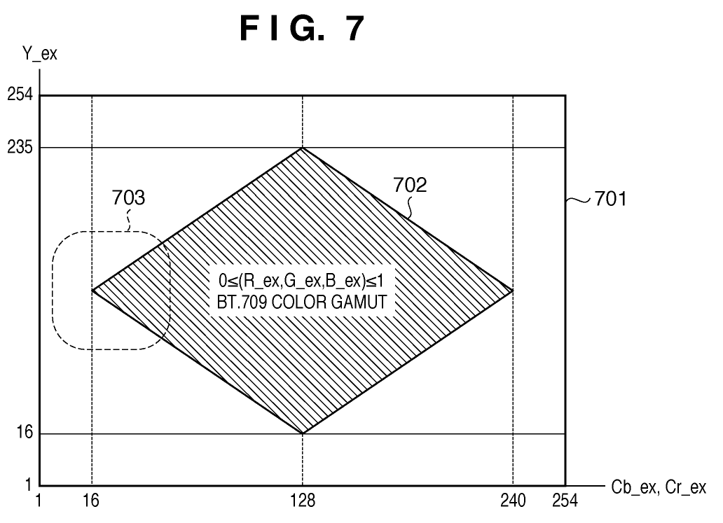

The range of the values of the luminance signal Y_ex and color difference signals Cr_ex and Cb_ex assigned the digital values is as shown in FIG. 7.

A region enclosed within a rectangular 701 in FIG. 7 represents the range of the values of the luminance signal Y_ex and color difference signals Cr_ex and Cb_ex.

A hatched region 702 in FIG. 7 represents a range when each of the R_ex, G_ex, and B_ex signal takes a value between 0 and 1 (both inclusive), which corresponds to the BT.709 color gamut described above.

That is, in FIG. 7, the region outside the region 702 is a region when any one of the R_ex, G_ex, and B_ex signals takes a negative value or a value larger than 1.

The luminance signal Y_ex and color difference signals Cr_ex and Cb_ex processed by the first color gamut signal processor 103-1 are output from a terminal 103a of the camera signal processor 103 and input to each of a terminal 104a of the first selector 104 and a terminal 105a of the second selector 105.

On the other hand, the signals processed by the first color gamut signal processor 103-1 are also input to the second color gamut signal processor 103-2 that is in the camera signal processor 103.

Note that this embodiment exemplifies a case in which the luminance signal Y_ex and color difference signals Cr_ex and Cb_ex processed by the first color gamut signal processor 103-1 are input to the second color gamut signal processor 103-2.

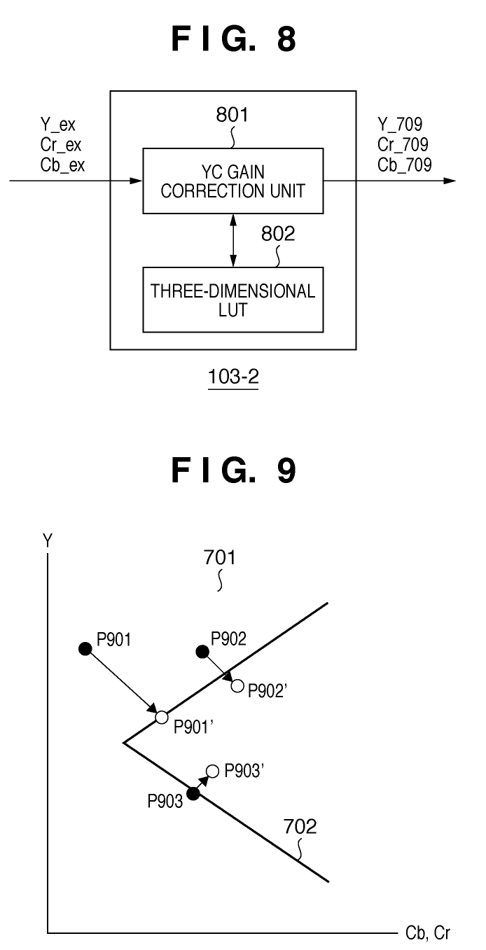

The second color gamut signal processor 103-2 performs processing so as to convert the signals processed by the first color gamut signal processor 103-1 to those in a second color gamut. The arrangement of the second color gamut signal processor 103-2 is shown in FIG. 8.

In FIG. 8, reference numeral 801 denotes a YC gain correction unit that corrects the gains of a luminance signal and color difference signals in accordance with the data of a three-dimensional (3D) lookup table to be described later.

Reference numeral 802 denotes a lookup table (LUT hereinafter) that has gain correction data corresponding to a 3D signal formed by three signals, that is, the input luminance signal Y_ex and color difference signals Cr_ex and Cb_ex.

An example of the gain correction operation of the second color gamut signal processor having the above-described arrangement will be described with reference to FIG. 9.

FIG. 9 is an enlarged view of a portion indicated by a region 703 enclosed within a dashed line in FIG. 7. Note that this process is originally 3D correction using luminance and color difference. For the sake of simplicity, however, the process will be described using a 2D graph shown in FIG. 9.

For example, assume that the luminance signal Y_ex and color difference signals Cr_ex and Cb_ex take values P901, P902, and P903 shown in FIG. 9, respectively. In this case, a correction process is performed to convert the values P901, P902, and P903 into values P901′, P902′, and P903′, respectively, by looking up the gain correction data of the LUT so that each value falls inside the region 702.

That is, when such a gain correction process is performed, all signals present outside the region 702 in FIG. 7 are compressed into values inside the region 702. Accordingly, all the signals are compressed into values in the BT.709 color gamut.

Note that a method of compressing a signal into a value in a particular color gamut by gain correction as described above need not be a correction pattern illustrated in FIG. 9. For example, as a color gamut compression method, various methods are known such as a method of compressing a color gamut so as to minimize the color difference between before and after the compression, a method of compressing a color gamut while keeping the luminance unchanged, a method of compressing a color gamut while keeping the hue unchanged, and the like.

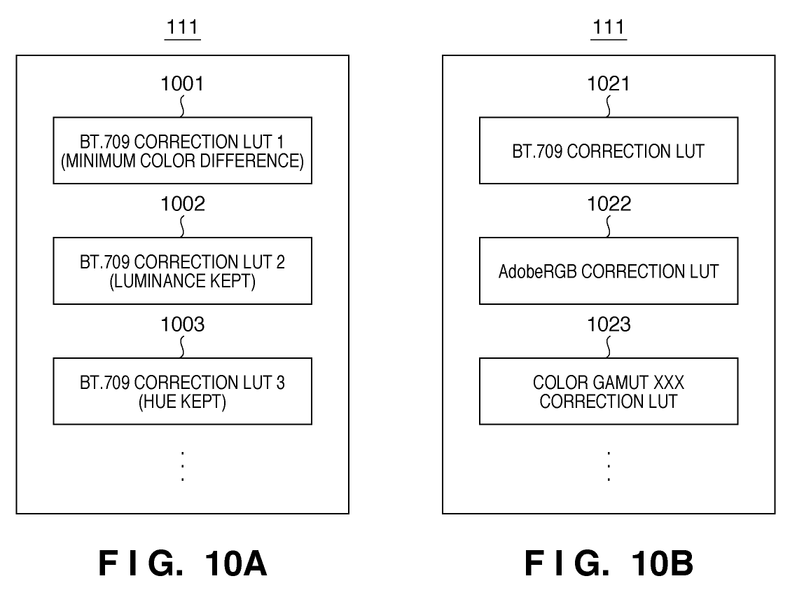

In addition, as illustrated in FIG. 10A, gain correction LUTs 1001 to 1003 corresponding to a plurality of color gamut compression methods may be recorded in the memory 111, and a user may be able to select the type of a color gamut compression method to be used. In this case, the gain correction LUT corresponding to the type selected by the user is read from the memory 111 to the 3D LUT 802 in FIG. 8.

A luminance signal Y_709 and color difference signals Cr_709 and Cb_709 converted into the BT.709 color gamut by the second color gamut signal processor 103-2 are output from a terminal 103b of the camera signal processor 103 and input to each of a terminal 104b of the first selector 104 and a terminal 105b of the second selector 105.

Next, the operation of the first selector 104 and that of the second selector 105 to which the signals processed using the above-described two color gamuts are input will be described.

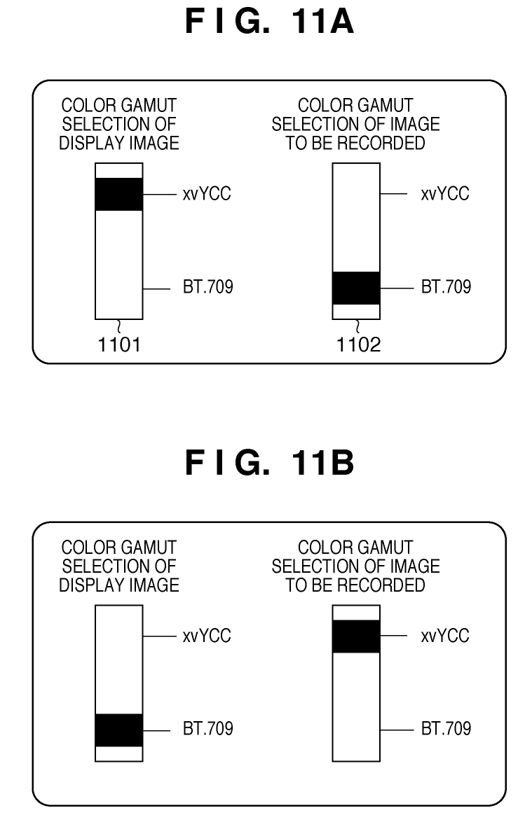

FIGS. 11A and 11B show examples of menu windows for selecting a color gamut of the image displaying unit and that of the image recording unit.

In FIGS. 11A and 11B, reference numeral 1101 denotes a portion for selecting the color gamut of an image to be displayed on the image displaying unit 106, and reference numeral 1102 denotes a portion for selecting the color gamut of an image to be recorded. The selection state of each of these portions can be changed independently.

The example shown in FIG. 11A illustrates a state in which the xvYCC color gamut is selected for displaying an image on the image displaying unit 106 and the BT.709 color gamut is selected for recording an image.

The example shown in FIG. 11B illustrates a state in which the BT.709 color gamut is selected for displaying an image on the image displaying unit 106 and the xvYCC color gamut is selected for recording an image.

When the operation unit 110 is set as in FIG. 11A, the system controller 109 outputs a control signal to the first selector 104 so as to select the signal from the terminal 104a, and outputs a control signal to the second selector 105 so as to select the signal from the terminal 105b.

As a result, the image processed using the xvYCC color gamut is displayed on the image displaying unit 106, and the image processed using the BT.709 color gamut is output to the image recording unit 107.

When the operation unit 110 is set as in FIG. 11B, the system controller 109 outputs a control signal to the first selector 104 so as to select the signal from the terminal 104b, and outputs a control signal to the second selector 105 so as to select the signal from the terminal 105a.

As a result, the image processed using the BT.709 color gamut is displayed on the image displaying unit 106, and the image processed using the xvYCC color gamut is output to the image recording unit 107.

In this manner, the image displaying unit 106 has the first selector 104 and the image recording unit 107 has the second selectors 105 to select an image, and each of the selectors can independently select an image signal from a plurality of image signals processed for a plurality of color gamuts in the camera signal processor 103.

That is, even when the video camera is recording a moving image, it is possible to switch only the first selector 104 to arbitrarily switch and display an image processed using the xvYCC color gamut or an image processed using the BT.709 color gamut on the image displaying unit 106, while maintaining the selection state of the second selector 105 unchanged.

Accordingly, it becomes possible to switch images processed using a plurality of color gamuts and display them on the image displaying unit 106 to confirm them, without affecting an image being recorded.

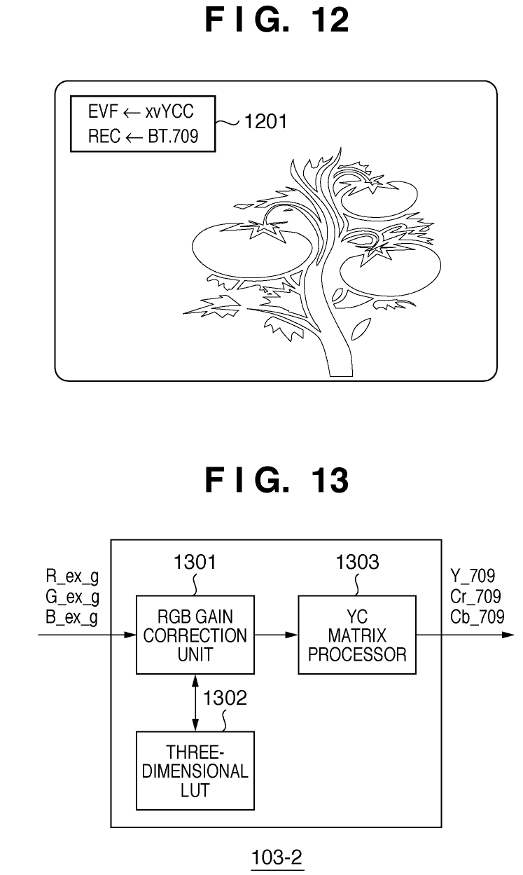

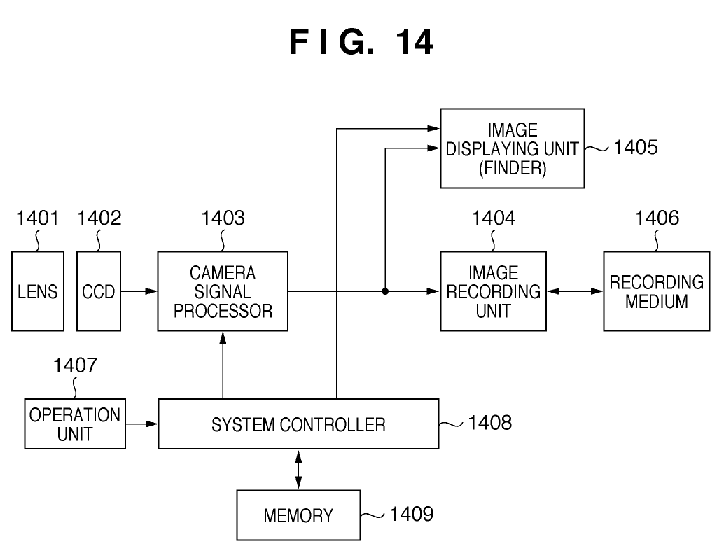

FIG. 12 illustrates an example of display by the image displaying unit of this embodiment. As indicated by reference numeral 1201, the image displaying unit may be arranged to display the color gamut information of an image selected by the image recording unit 107 (REC) and that of an image selected by the image displaying unit 106 (EVF) so that a user can visually confirm them.

In addition, when the image displaying unit 106 is arranged to be able to display the primary color points (chromaticity points) of the widest color gamut of a plurality of color gamuts which the camera signal processor 103 can process, a change in tint upon switching the color gamuts can be recognized more easily.

When image recording has been started while the color gamut of the image to be recorded and that of the image displayed on the image displaying unit 106 are different, a warning may be issued to a user by flashing the color gamut information 1201 in FIG. 12, or the like.

In addition, the second color gamut signal processor 103-2 is not limited to process the BT.709 color gamut, but it may be arranged to be able to compress a color gamut into a plurality of other color gamuts narrower than a first color gamut.

More specifically, as illustrated in FIG. 10B, gain correction LUTs 1021 to 1023 that correspond to a plurality of other color gamuts (e.g., AdobeRGB and the like) narrower than xvYCC are stored in the memory 111, in addition to the BT.709 color gamut. In this case, a user may be able to select the type of the color gamut used for compression.

Note that this embodiment has exemplified a case in which the luminance signal Y_ex and color difference signals Cr_ex and Cb_ex processed in the first color gamut signal processor 103-1 are input to the second color gamut signal processor 103-2. However, the processing method in the second color gamut signal processor 103-2 is not limited to this. For example, as shown in FIG. 13, R, G, and B signals that underwent gamma processing in the first color gamut signal processor 103-1 may be input to the second color gamut signal processor 103-2 and undergo color gamut compression. In this case, the 3D LUT 1302 shown in FIG. 13 is arranged to hold gain correction values for correcting R, G, and B signals.

Also, a case has been exemplified in which the two color gamut signal processors 103-1 and 103-2 are provided in the camera signal processor 103. However, three or more color gamut signal processors may be provided. In this case, the image displaying unit 106 and image recording unit 107 can independently and arbitrarily select one of image signals processed in the respective color gamut signal processors.

Of course, the color gamuts to be processed are not limited to xvYCC and BT.709, and may be other color gamuts such as AdobeRGB, WideGamutRGB, ITU-R BT.601, and the like.

### Other Embodiment

The present invention is applicable when the respective signal processors are implemented by hardware and also when they are implemented by software processing using a computer. The same effect can be obtained in either case. In this case, the program codes of the above-described software implement the functions of the above-described embodiment by themselves. The program codes themselves and a device (e.g., a storage medium storing the program codes) for supplying the program codes to a computer are included in the present invention. As a storage medium for storing the program codes, for example, a floppy (registered trademark) disk, a hard disk, an optical disk, a magnetooptical disk, a CD-ROM, a magnetic tape, a nonvolatile memory card, a ROM, or the like can be used.

The functions of the above-described embodiment are implemented not only when the supplied program codes are executed by the computer. That is, the program codes are included in the embodiment of the preset invention also when the program codes cooperate with the OS running on the computer or other application software so as to implement the functions of the above-described embodiment.

Furthermore, the supplied program codes are stored in a memory included in a function expansion board of the computer or a function expansion unit connected to the computer. Then, the CPU or the like of the function expansion board or function expansion unit performs part or all of actual processing on the basis of the instructions of the program codes so that the functions of the above-described embodiment are implemented by this processing.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-320064, filed Dec. 11, 2007, which is hereby incorporated by reference herein in its entirety.

What is claimed is:

1. An image sensing apparatus comprising:
an image sensing unit adapted to sense an image of an object;
a signal processor adapted to perform processing corresponding to a plurality of color gamuts for image data obtained by said image sensing unit;
an image recording unit adapted to record image data processed by said signal processor;
an image displaying unit adapted to display image data processed by said signal processor;
a first selector adapted to select a color gamut of image data to be recorded in said image recording unit from the plurality of color gamuts; and
a second selector adapted to select a color gamut of image data to be displayed on said image displaying unit from the plurality of color gamuts,
wherein during recording of image data of the color gamut selected by said first selector in said image recording unit, image data of a plurality of color gamuts are displayed on said image displaying unit by switching selection by said second selector while maintaining a selection state by said first selector.

2. The apparatus according to claim 1, wherein said signal processor includes a first color gamut signal processor adapted to perform processing based on a first color gamut for image data output from said image sensing unit, and a second color gamut signal processor adapted to input image data processed by said first color gamut signal processor and perform processing based on a second color gamut.

3. The apparatus according to claim 2, wherein said second color gamut signal processor performs processing based on the second color gamut narrower than the first color gamut processed by said first color gamut signal processor.

4. The apparatus according to claim 2, wherein said second color gamut signal processor converts image data to those in a plurality of second color gamuts narrower than the first color gamut.

5. The apparatus according to claim 1, wherein said image displaying unit displays color gamut information of image data recorded in said image recording unit and color gamut information of image data displayed on said image displaying unit.

6. The apparatus according to claim 1, further comprising a warning unit adapted to, when a color gamut of image data recorded in said image recording unit and a color gamut of image data displayed on said image displaying unit are different, issue a warning for a user for a predetermined period of time, indicating that those color gamuts are different.

7. The apparatus according to claim 1, wherein said image displaying unit displays a chromaticity point corresponding to a widest color gamut of a plurality of color gamuts processed by said signal processor.

8. A control method of an image sensing apparatus including an image sensing unit adapted to sense an image of an object, a signal processor adapted to perform processing corresponding to a plurality of color gamuts for image data obtained by said image sensing unit, an image recording unit adapted to record image data processed by said signal processor, and an image displaying unit adapted to display image data processed by said signal processor, comprising:
a first selection step of selecting a color gamut of image data to be recorded in said image recording unit from the plurality of color gamuts; and
a second selection step of selecting a color gamut of image data to be displayed on said image displaying unit from the plurality of color gamuts,
wherein during recording of image data of the color gamut selected in the first selection step in said image recording unit, image data of a plurality of color gamuts are displayed on said image displaying unit by switching selection in the second selection step while maintaining a selection state in the first selection step.

9. The method according to claim 8, further comprising a first color gamut processing step of causing said signal processor to perform processing based on a first color gamut for image data output from said image sensing unit, and a second color gamut signal processing step of inputting image data processed in said first color gamut signal processing step and performing processing based on a second color gamut.

10. The method according to claim 9, wherein in the second color gamut signal processing step, processing based on the second color gamut narrower than the first color gamut processed in the first color gamut signal processing step is performed.

11. The method according to claim 9, wherein in the second color gamut signal processing step, image data is converted into those in a plurality of second color gamuts narrower than the first color gamut.

12. The method according to claim 8, further comprising a display step of causing said image displaying unit to display color gamut information of image data recorded in said image recording unit and color gamut information of image data displayed on said image displaying unit.

13. The method according to claim 8, further comprising a warning step of, when a color gamut of image data recorded in said image recording unit and a color gamut of image data displayed on said image displaying unit are different, issuing a warning for a user for a predetermined period of time, indicating that those color gamuts are different.

14. The method according to claim 8, further comprising a display step of causing said image displaying unit to display a chromaticity point corresponding to a widest color gamut of a plurality of color gamuts processed by said signal processor.
